(19) United States
(12) Patent Application Publication
(10) Pub. No.: US 2021/0244977 A1
(43) Pub. Date: Aug. 12, 2021

(54) Novel Masks for Disease Prevention and Methods for Producing the Same

(71) Applicant: AnPac Bio-Medical Science Co., Ltd., Road Town (VG)

(72) Inventors: Chris C. Yu, Conneautville, PA (US); Xuedong Du, Shanghai (CN)

(73) Assignee: AnPac Bio-Medical Science Co., Ltd., Road Town (VG)

(21) Appl. No.: 17/172,911

(22) Filed: Feb. 10, 2021

Related U.S. Application Data
(60) Provisional application No. 62/975,102, filed on Feb. 11, 2020.

(51) Int. Cl. A62B 23/02; B01D 39/20; B01D 46/00; B01D 46/10; A41D 13/11; A62B 7/10

(52) U.S. Cl. CPC A62B 23/025; B01D 39/2068; B01D 46/0001; B01D 46/0005; B01D 46/10; A41D 13/11; A62B 18/084; B01D 2239/1216; B01D 2239/065; B01D 2239/10; B01D 2275/10; B01D 2239/0478; A62B 7/10

(57) ABSTRACT

Among others, the present invention provides masks each with mask filter or mask body comprising one or more filter layers fabricated by integrated circuit fabrication processes. Such filter layer includes well-defined and substantially uniform pore size, and allows the mask to be washable and reusable. The prevention invention also provides methods for fabricating a single layer or multi-layer mask body or mask filter to be incorporated by a face mask.

### CROSS-REFERENCE TO RELATED APPLICATIONS

This application claims priority to U.S. Application No. 62/975,102, filed Feb. 11, 2020, the contents of which are incorporated herein by reference in their entirety.

### BACKGROUND OF THE INVENTION

One of the most effective ways to prevent respiratory diseases is to wear a face mask with a right pore size, for example, N95 is a widely used mask for the above-mentioned purpose. However, the conventional mask, such as N95, has a limited effective life and can only be used for a short period of time, mostly, a disposable mask. Due to its limited life span, the cost of using the conventional mask is high. Furthermore, pore size of the filter within a conventional mask is not uniformly distributed that could potentially allow small size particles such as viruses to penetrate through the mask.

Therefore, it would be desirable and highly advantageous to have a novel face mask comprising a filter component with well-defined, substantially uniform pore size to enhance the filtration efficiency and prevent diseases, and have a washable/reusable property to reduce the cost of using a mask.

### SUMMARY OF THE INVENTION

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

This invention generally relates to filter component (either as a mask body, or as a mask filter removably inserted into a pocket of a mask body, such as a cloth mask body) comprising one or more filter layers fabricated by integrated circuit fabrication processes. The filter layer according to the present invention can be made of materials such as silicon dioxide and polysilicon. The resulting mask filter or mask body can have a well-defined and substantially uniform pore size. Thus, a face mask incorporating such mask filter or mask body significantly enhances the filtration efficiency and effectively prevents viruses from penetrating the mask. Also, the mask filter or mask body according to the present invention can be reusable and washable, thereby substantially save costs for wearers. The present invention further provide method for preparing such mask body or mask filter, using integrated circuit fabrication technologies and processes.

One aspect of this invention relates to a mask filter comprising at least one filter layer, wherein the at least on filter layer is fabricated by integrated circuit fabrication processes.

In some embodiments, the at least one filter layer is made of a material comprising silicon dioxide or polysilicon.

In some embodiments, the at least one filter layer has a substantially uniform pore size.

In some embodiments, the pore size is in a range of 0.1 micron to 100 microns. In some further embodiments, the pore size is in a range of 1 micron to 10 microns, or even a range of 1 micron to 3 microns.

In some embodiments, the mask filter comprises multiple filter layers to form a three-dimensional, integrated structure to further enhance filtration.

In some embodiments, the sizes of the pores, or the placements of the pores in different filter layers are the same or different, designed in a way to optimize filtration efficiency and life time between cleaning.

In some embodiments, the mask filter is reusable and washable. For instance, the mask filter can be cleaned by a virus-killing solution, with megasonic cleaning processes (mega-sonic energy) imparted to improve cleaning efficiency.

In some embodiments, the mask filter is configured to be removably inserted into a housing or pocket of a mask, thereby effectively preventing particles in a wearer's immediate environment from penetrating the mask and being inhaled into the wearer's respiratory system.

In some embodiments, the particles comprise viruses, bacterial, mildew, pollen, or mites

In some embodiments, the mask is a cloth mask having the housing or pocket for holding the mask filter.

In some other embodiments, the mask filter forms a mask body of a mask, wherein the mask further comprises a means for securing the mask body over the mouth and nose of the wearer, thereby effectively preventing the particles in the wearer's immediate environment from penetrating the mask and being inhaled into the wearer's respiratory system.

In some embodiments, the integrated circuit fabrication processes comprise thin film deposition, lithography, wet etch, dry etch, cleaning, wet processing, diffusion, ion implantation, annealing, or chemical mechanical polishing.

Another aspect of the present invention provides a face mask comprising a mask body, and a means for securing the mask body over the mouth and nose of the wearer; wherein the mask body comprises one or more filter layers fabricated by integrated circuit fabrication technologies.

In some embodiments, each filter layer has a substantially uniform pore size ranging from 0.1 micron to 100 microns (e.g., 1 micron to 10 microns, or 1 micron to 3 microns).

In some embodiments, each filter layer is made of a material comprising silicon dioxide or polysilicon.

In some embodiments, the mask body comprises multiple filter layers to form a three-dimensional, integrated structure to further enhance filtration.

In some embodiments, the sizes of the pores, or the placements of the pores in different filter layers are the same or different, configured for optimizing filtration efficiency and life time between cleaning.

In some embodiments, the integrated circuit fabrication processes comprise thin film deposition, lithography, wet etch, dry etch, cleaning, wet processing, diffusion, ion implantation, annealing, or chemical mechanical polishing.

In some embodiments, the mask body comprises a pocket, wherein the one or more filter layers are removably inserted into the pocket.

In some embodiments, the pocket is made of a different material (e.g., cloth) from the material for the one or more filter layers.

In some embodiments, the securing means comprises elastic cord, elastic band, strings, ties or straps to be placed around the ear or around the back of the wearer's head.

In a further aspect, the present invention provides a method for fabricating a mask filter or mask body of a face mask, comprising: providing a wafer substrate having a surface region; depositing a first material A on the surface region of the wafer substrate; depositing a second material B on the surface region of the first material A; coating a resist layer on the surface region of the second material B; patterning the resist layer to form recessed areas, using at least one of lithography and etching processes; etching into the second material B which is selective to the first material A to form pores; removing the resist layer, and lifting off the left second material B via etching away the first material A to form a mask filter or mask body with well-defined pores.

In some embodiments, the method comprises the following steps before the last lifting step: depositing a third material C on the surface region of the second material B and filling into the pores in the second material B; planarization of the top surface of the third material C using etching, chemical or mechanical polishing techniques; etching holes into the third material C, to form supporting pillars between mask layers; depositing a fourth material D on the surface region of the third material C and filing into the holes in third material C; coating a resist layer on the surface region of the fourth material D; patterning the fourth material D using at least one of lithography and etching processes; etching through the existing fourth material D which is selective to the third material C to form pores, etching away the third material C, and lifting off the left materials B and D via etching away the first material A to form a double-layered mask filter or mask body with well-defined pores, wherein the pores in the second material B form pores in a first layer, and the pores in the fourth material D form pores in a second layer.

In still a further aspect, the present invention provides a method for fabricating a mask filter or mask body of a face mask, comprising: providing a wafer substrate having a surface region; coating a resist layer on the surface region of the wafer substrate; patterning the resist layer, using at least one of lithography and etching processes; etching into the wafer substrate to form pores, and removing the resist layer to form a mask filter or mask body in the substrate layer with well-defined pores.

In some embodiments, the wafer substrate is a silicon water substrate.

In some embodiments, the first material A comprises silicon dioxide.

In some embodiments, the second material B comprises polysilicon.

In some embodiments, the third material C comprises silicon dioxide.

In some embodiments, the fourth material D is the same material as the second material B.

In some embodiments, the etching process comprises dry etching or wet etching.

In some embodiments, the mask filter or mask body is further cut into desired dimensions. For instance, the mask body is cut into desired dimensions via die cutting process.

In some embodiments, the cutting process is performed before or after the last lifting step.

In some embodiments, the steps of depositing, planarizing and etching the third material C, and depositing and patterning the fourth material D are repeated one or more times to form a mask comprising multiple filter layers.

In some embodiments, the pore sizes are the same or different between different filter layers.

In some embodiments, the placements of the pore at different filter layers are the same or different.

It is also an object of the present invention to provide a face mask comprising a mask body to cover at least the mouth and nose of a wearer and a securing means to ensure a tight engagement between the mask body and the face of a wearer when the face mask is worn. The mask body comprises one or more layers of filter component with pores of substantially uniformed size, thereby efficiently prevent viruses from penetrating through the mask. Moreover, multiple layers of the filter component can form a three-dimensional structure and further enhance and secure the filtration efficiency. In addition, the mask is made of materials, such as silicon dioxide or polysilicon, which are washable and reusable, thereby greatly reduce the cost of using the novel mask. An integrated circuit (IC) process for fabrication the face mask by using a lithography process is also disclosed.

In some embodiments, the mask comprises a mask body and a securing means. The mask body is made of an adaptive material and can fit over a wearer's mouth and nose. The securing means can ensure the mask over the mouth and nose of the wearer. Furthermore, the mask body comprises one or more layers of filter component with pores of substantially uniformed size to enhance the filtration efficiency.

In some embodiments, the pore is in a range of 0.1 micron to 100 microns, preferably, in a range of 1 micron to 10 microns, more preferably, in a range of 1 micron to 3 microns.

In some embodiments, the filter component is made of materials comprise silicon dioxide and polysilicon.

In some embodiments, the filter component is made by integrated circuit fabrication technologies.

In some embodiments, the mask is washable and reusable. And the mask is washed and cleaned by megasonic cleaning in a virus-killing solution.

In some embodiments, the mask body having top and bottom edges. The top edge extends across the wearer's nose and cheeks, and the bottom edge extends under the wear's chin to create an interior space between the top edge and the bottom edge of the mask body when the face mask is worn.

In some embodiments, the securing means is attached to the mask body adjacent to each end of the top and bottom edges for causing tight engagement between the mask body and the face of the wearer, thereby preventing potential particles from flowing into the interior space via the top edge or the bottom edge of the mask body. The securing means comprises elastic cord, elastic band, strings, ties or straps to be placed around the ear or around the back of the wearer's head.

In some embodiments, the face mask is effective in preventing particles in the wearer's immediate environment from penetrating the mask and being inhaled into the wearer's respiratory system. The particles comprise viruses, bacterial, mildew, pollen or mites.

In a further aspect, the present invention provides a method for fabricating the novel mask of this invention. Each method includes the steps of providing a wafer substrate having a surface region, depositing a first material A on the surface region of the wafer substrate, depositing a second material B on the surface region of the first material A, coating a resist layer on the surface region of the second material B, patterning the second material B using at least one of lithography and etching processes, etching through the existing second material B which is selective to the first material A to form pores, removing the resist layer, and lifting off the left second material B via etching away the first material A to form a mask body with well-defined pores.

Alternatively, the method for fabricating a novel mask of this invention includes the steps of providing a wafer substrate having a surface region, coating a resist layer on the surface region of the wafer substrate, patterning the wafer substrate using at least one of lithography and etching processes, etching through the existing wafer substrate to form pores, and removing the resist layer to form a mask body in the substrate layer with well-defined pores.

In some embodiments, the methods further includes the following steps before the last lifting step: depositing a third material C on the surface region of the second material B, planarization of the top surface of the third material C using etching, chemical or mechanical polishing techniques, etching holes into the third material C, depositing a fourth material D on the surface region of the third material C, coating a resist layer on the surface region of the fourth material D, patterning the fourth material D using at least one of lithography and etching processes, etching through the existing fourth material D which is selective to the third material C to form pores, etching away the third material C, and lifting off the left materials B and D via etching away the first material A to form a double-layered mask body with well-defined pores.

One example of a suitable wafer substrate is a silicon substrate. An example of the first material A is silicon dioxide. An example of the second material B is polysilicon. An example of the third material C comprises silicon dioxide. The fourth material D can be the same as or different from the second material B.

In some other embodiments of the methods of this invention, the etching process comprises dry etching or wet etching.

In some other embodiments, the mask body is further cut into desired dimensions. For example, the mask body can be cut into desired dimensions via die cutting process. The cutting process can be performed before or after the last lifting step.

In still some other embodiments, the steps of depositing, planarizing and etching the third material C, and depositing and patterning the fourth material D are repeated one or more times to form a mask comprising multiple layers of filter components.

In yet still some other embodiments, the pore sizes are the same or different between different layers.

In additional embodiments, the placements of the pore at different layers are the same or different.

As used herein, the term “or” is meant to include both “and” and “or.” In other words, the term “or” may also be replaced with “and/or.”

As used herein, the singular forms “a,” “an” and “the” are intended to include the plural forms as well, unless the context clearly indicates otherwise.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIGS. 1(a)-1(e) illustrate a process for fabricating a mask body or mask filter according to one embodiment of the present invention.

FIGS. 2(a)-2(c) illustrate another process for fabricating a mask body or mask filter according to one embodiment of the present invention.

FIGS. 3(a)-3(j) illustrate a process for fabricating a mask body or mask filter with multiple filter layers, according to one embodiment of the present invention.

### DETAILED DESCRIPTION OF THE INVENTION

Reference will now be made in detail to the preferred embodiments of the invention, examples of which are further illustrated. While the invention will be described in conjunction with the preferred embodiments, it will be understood that they are not intended to limit the invention to these embodiments. To the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and other features have not been described in detail as not to unnecessarily obscure aspects of the present invention.

Generally speaking, various embodiments of the present invention provide for novel filter design for a face mask, either as a mask filter removably inserted into a pocket of a mask or as a mask body together with a securing means (e.g., elastic cord, elastic band, strings, ties or straps) to form a face mask. In particular, the mask filter or mask body according to the present invention includes one or more filter layers fabricated by integrated circuit fabrication processes. Examples of the integrated circuit fabrication processes include, but are not limited to, thin film deposition, lithography, etch (both wet and dry etch processes), cleaning, wet processing, diffusion, ion implantation and chemical mechanical polishing (“CMP”) processes. The filter layer according to the present invention can be made of a variety of materials suitable for integrated circuit fabrication processes, such as silicon dioxide and polysilicon.

Accordingly, the resulting mask filter or mask body not only can have a well-defined and substantially uniform pore size, but also is washable and thus reusable. Thus, a face mask incorporating such mask filter or mask body may achieve improved filtration efficiency and effectively prevents viruses from penetrating the mask, while being reusable and saving costs at the same time.

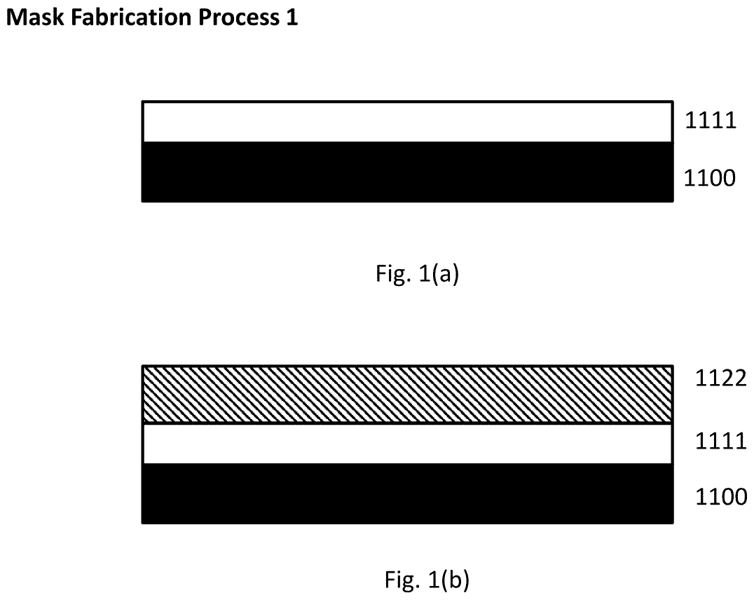

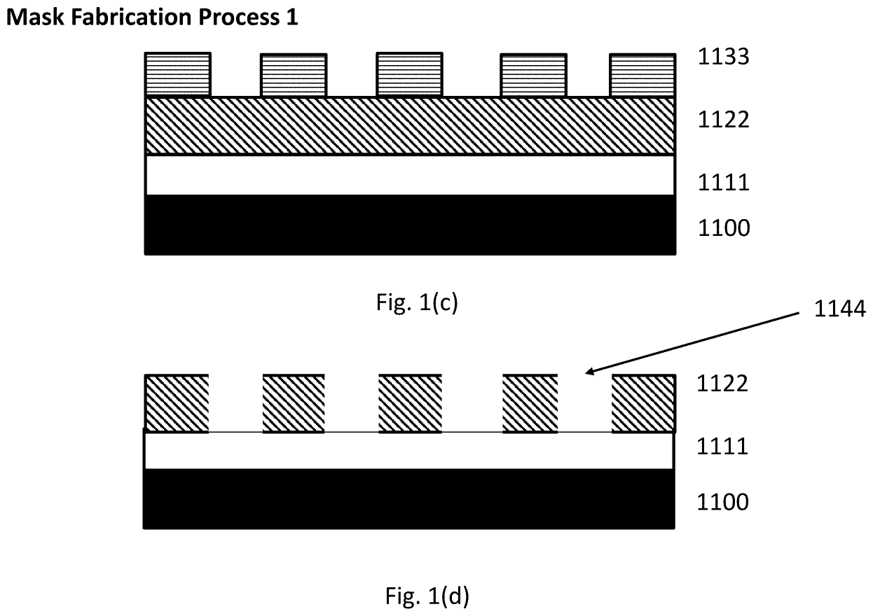

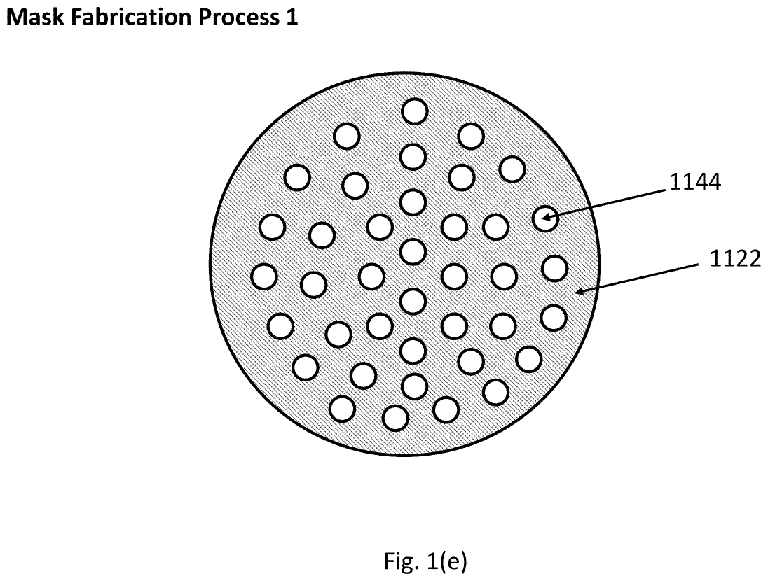

FIGS. 1(a)-1(e) illustrate an exemplary process for fabricating a mask (e.g., a mask filter or mask body thereof). As shown in FIG. 1(a), material 1111 (for example, silicon dioxide) is first deposited on a wafer substrate 1100 (for example, a silicon wafer). As shown in FIG. 1(b), a second material 1122 (for example, polysilicon) is deposited on the material 1111. As shown in FIG. 1(c), a resist layer 1133 is then applied on the second material 1122 by spin coating. FIG. 1(d) illustrates steps of etching material 1122 which is selective to material 1111 via dry etching or wet etching process and stripping off the resist layer 1133. After fabrication steps (a) through (d), holes (pores) 1144 are formed in material 1122. Then material 1122 can be lifted off via etching away material 1111 to form a mask, or material 1122 can be cut into a desired size before or after lifting. FIG. 1(e) shows the top view of material 1122 (mask body or mask filter) after fabrication steps (a) through (d). Using state of the art technology, the holes (pores) 1144 can be as small as a fraction of one micron (um) or even smaller. In practice for this application, the proposed range is 1 to 3 microns.

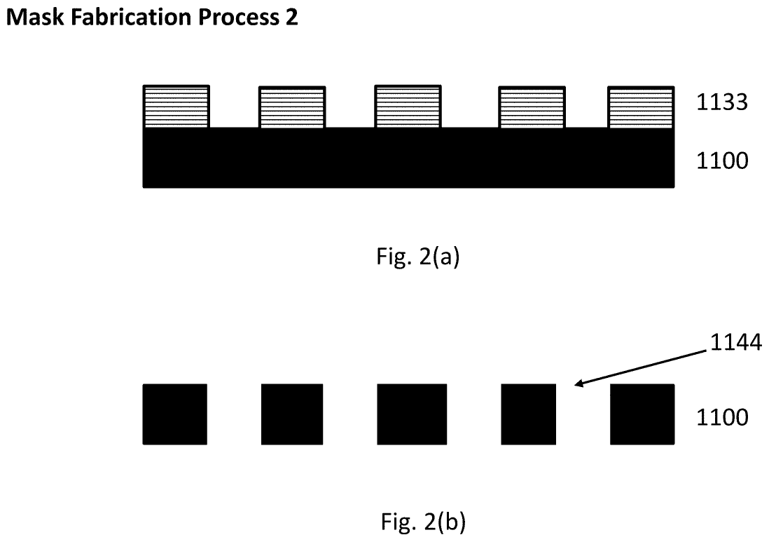

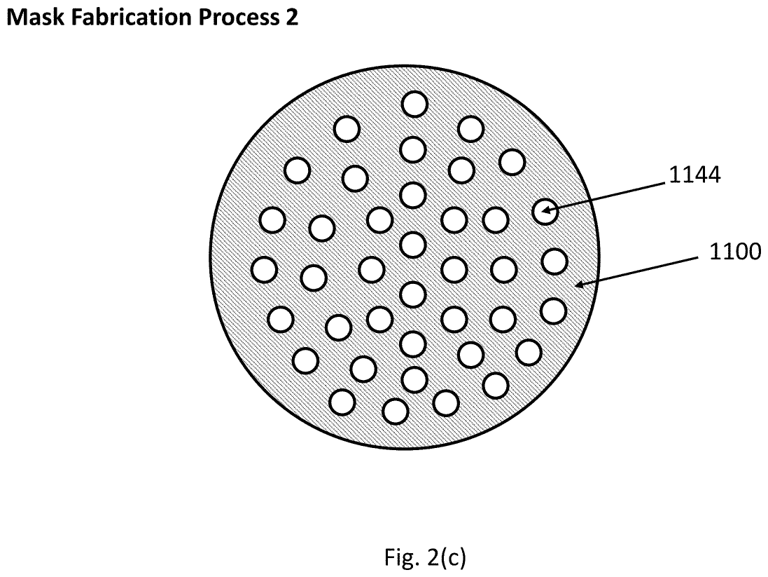

FIGS. 2(a)-2(c) illustrate another exemplary process for fabricating a mask (e.g., a mask filter or mask body thereof). As shown in FIG. 2(a), a resist layer 1133 is coated onto a wafer substrate 1100 (for example, a silicon wafer) by spin coating. FIG. 2(b) illustrates steps of etching into substrate 1100 using wet etching or dry etching process, and stripping off the resist layer 1133. Then, holes (or pores) 1144 are formed in substrate 1100 (mask body). FIG. 2(c) shows the top view of substrate 1100 after fabrication steps (a) and (b). Using state of the art technology, the holes (pores) 1144 can be as small as a fraction of one micron (um) or even smaller. In practice for this application, the proposed range is 1 to 3 microns.

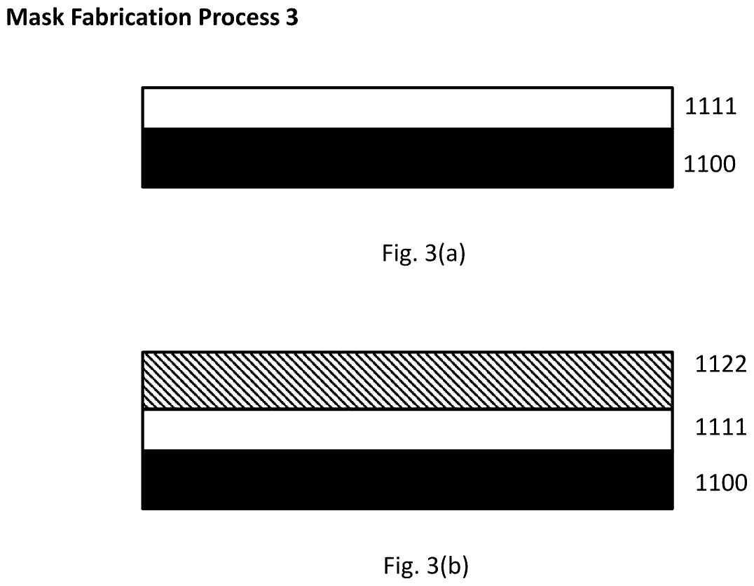

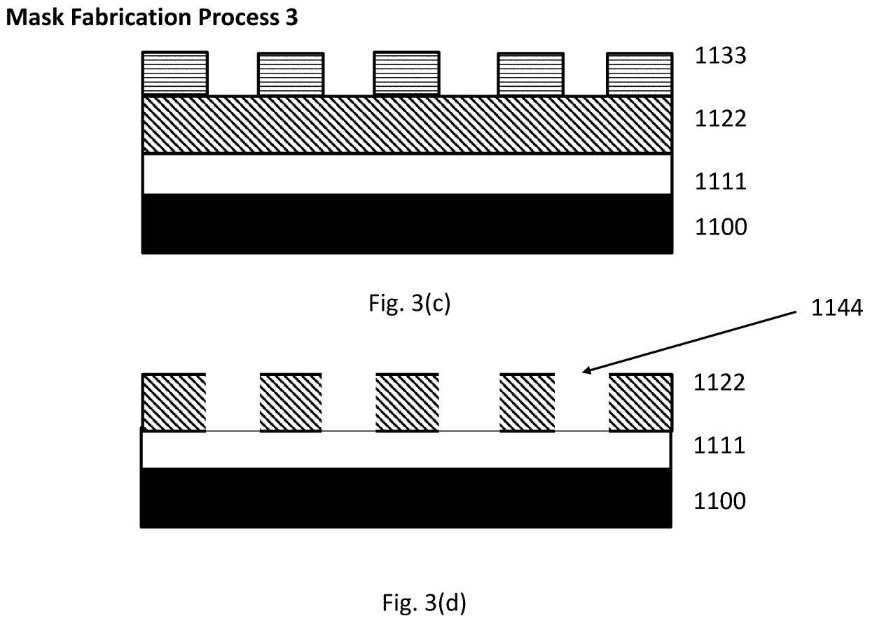

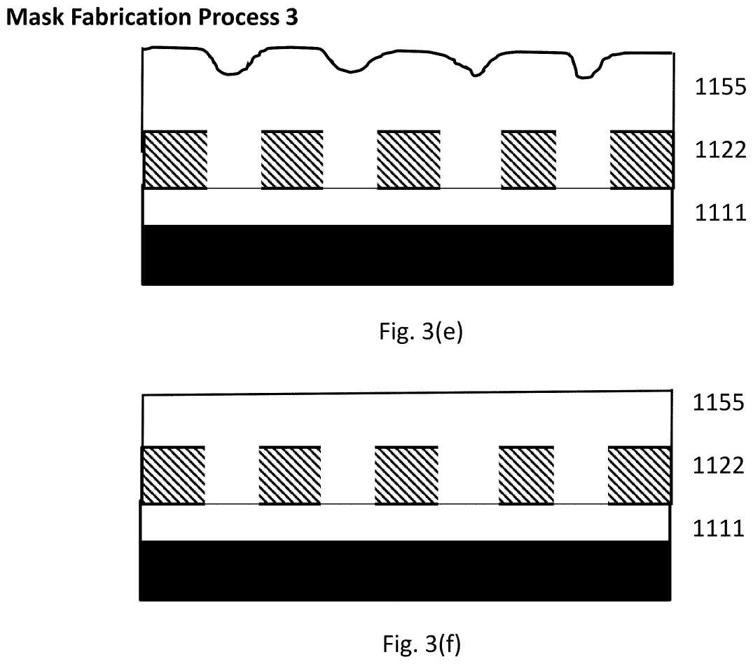

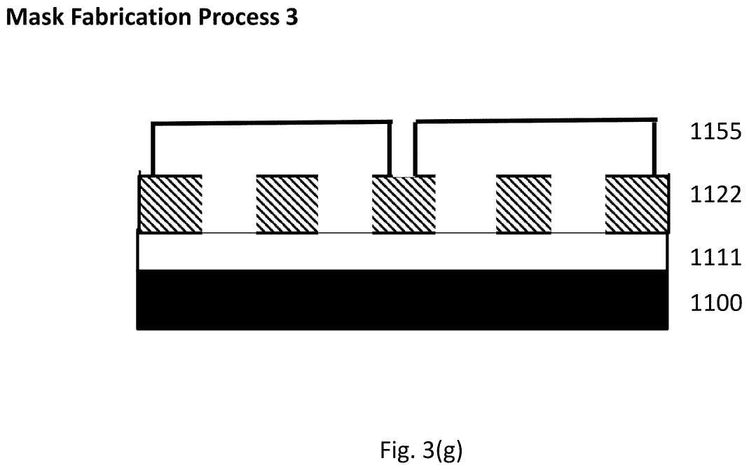

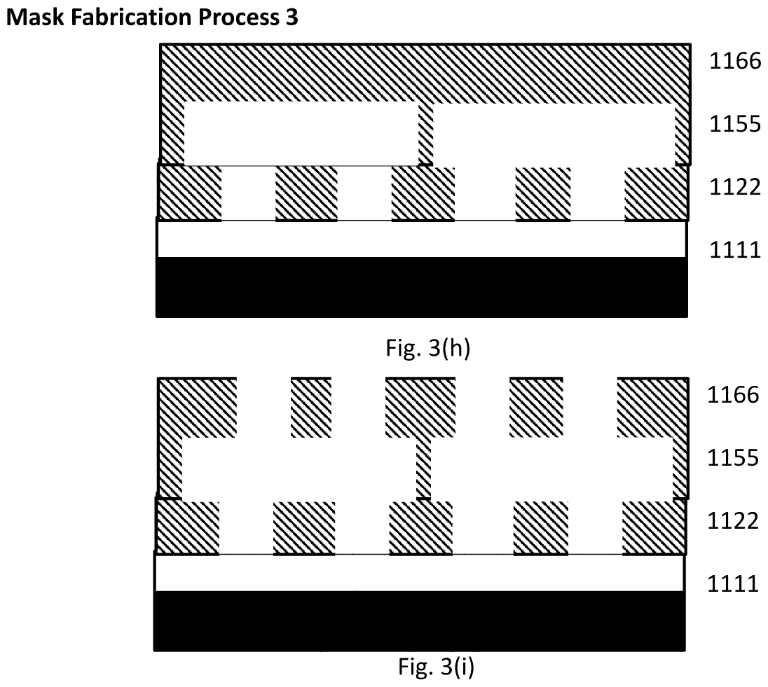

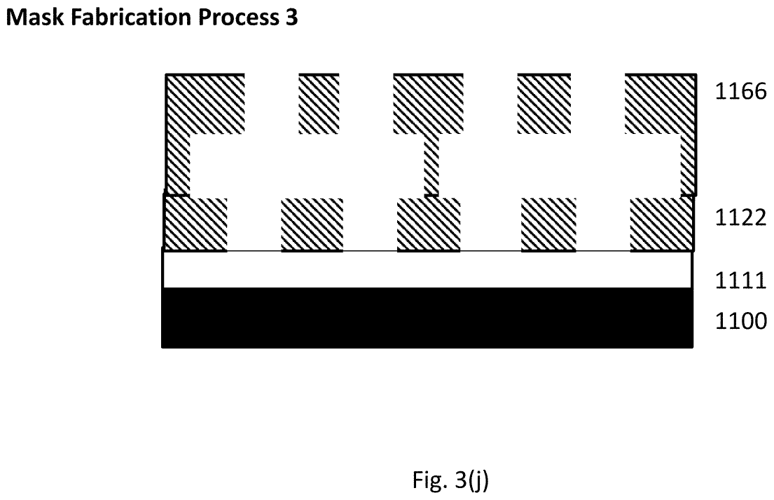

Further, FIGS. 3(a)-3(j) illustrate another process for fabricating a multi-layer mask. As shown in FIG. 3(a), a material 1111 (for example, silicon dioxide) is deposited on a wafer substrate 1100 (for example, a silicon wafer). As shown in FIG. 3(b), a second material 1122 (for example, polysilicon) is deposited on the material 1111. In FIG. 3(c), a resist layer 1133 is applied on the material 1122 by spin coating. FIG. 3(d) illustrates steps of etching material 1122 which is selective to material 1111 via dry etching or wet etching process and stripping off the resist layer 1133. After steps (a)-(d), holes (pores) 1144 are formed in material 1122. In FIG. 3(e), a material 1155 (for example, silicon dioxide) is deposited on the material 1122. FIG. 3(f) illustrates a step of planarization of material 1155 via etching, chemical or mechanical polishing. FIG. 3(g) illustrates a step of etching holes into material 1155 via a lithograph process, which will become the supporting pillars between two layers of mask body in the future. In FIG. 3(h), another material 1166 is deposited on the material 1155, preferably the same material as 1122. FIG. 3(i) illustrates a step of patterning material 1166 via a lithography process. Holes (pores) are formed in the material 1166. FIG. 3(j) illustrates a step of etching away material 1155 via wet or vapor (chemical vapor etching) etching process. Thus, a double-layered mask body has been fabricated using integrated circuit (IC) process technologies. The size and placement of the hole (pore) between the layers of the mask body can be different and they can be further optimized to maximize filtration efficiency and life time. The left materials B and D (mask body or mask filter with two layers) can be lifted off via etching away material 1111 (material 1111 and 1155 can be the same materials, for example, silicon dioxide). The mask body or mask filter can be cut into a desired size via die cutting process. Die cutting can be performed before or after the step of lifting.

The mask fabricated by a method disclosed in the present invention has significantly advantage in that the mask substantially increases the filtration capability and efficiency, even for the small particle in the size range of 1 micron to 0.1 microns, thereby more efficiently preventing diseases.

Another significant advantage is that the mask body is made of washable and reusable material, which greatly reduces the cost of using it.

The term “adaptive material” used herein after, means any material that is suitable for a face mask, comprising cloth, fiber or paper.

Although specific embodiments and examples of this invention have been illustrated herein, it will be appreciated by those skilled in the art that any modifications and variations can be made without departing from the spirit of the invention. The examples and illustrations above are not intended to limit the scope of this invention. Any combination of embodiments of this invention, along with any obvious their extension or analogs, are within the scope of this invention. Further, it is intended that this invention encompass any arrangement, which is calculated to achieve that same purpose, and all such variations and modifications as fall within the scope of the appended claims.

All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example of a generic series of equivalent or similar features.

### Other Embodiments

It is to be understood that while the invention has been described in conjunction with the detailed description thereof and accompanying figures, the foregoing description and accompanying figures are only intended to illustrate, and not limit the scope of the invention, which is defined by the scope of the appended claims. Other aspects, advantages, and modifications are within the scope of the following claims. All publications referenced herein are incorporated by reference in their entireties.

What is claimed is:

1. A mask filter comprising at least one filter layer, wherein the at least on filter layer is fabricated by integrated circuit fabrication processes.

2. The mask filter of claim 1, wherein the at least one filter layer is made of a material comprising silicon dioxide or polysilicon.

3. The mask filter of claim 1, wherein the at least one filter layer has a substantially uniform pore size.

4. The mask filter of claim 3, wherein the pore size is in a range of 0.1 micron to 100 microns, 1 micron to 10 microns, or 1 micron to 3 microns.

5. The mask filter of claim 4, comprising multiple filter layers to form a three-dimensional, integrated structure to further enhance filtration.

6. The mask filter of claim 5, wherein the sizes of the pores, or the placements of the pores in different filter layers are the same or different, configured for optimizing filtration efficiency and life time between cleaning.

7. The mask filter of claim 1, wherein the mask filter is reusable and washable.

8. The mask filter of claim 1, wherein the mask filter is configured to be removably inserted into a housing or pocket of a mask, thereby effectively preventing particles in a wearer's immediate environment from penetrating the mask and being inhaled into the wearer's respiratory system.

9. The mask filter of claim 8, wherein the particles comprise viruses, bacterial, mildew, pollen, or mites

10. The mask filter of claim 8, wherein the mask is a cloth mask having the housing or pocket for holding the mask filter.

11. The mask filter of claim 1, wherein the mask filter forms a mask body of a mask, wherein the mask further comprises a means for securing the mask body over the mouth and nose of the wearer, thereby effectively preventing the particles in the wearer's immediate environment from penetrating the mask and being inhaled into the wearer's respiratory system.

12. A face mask comprising a mask body, and a means for securing the mask body over the mouth and nose of the wearer; wherein the mask body comprises one or more filter layers fabricated by integrated circuit fabrication technologies.

13. The face mask of claim 12, wherein each filter layer has a substantially uniform pore size ranging from 0.1 micron to 100 microns.

14. The face mask of claim 12, wherein each filter layer is made of a material comprising silicon dioxide or polysilicon.

15. The face mask of claim 12, wherein the mask body comprises multiple filter layers to form a three-dimensional, integrated structure to further enhance filtration.

16. The face mask of claim 15, wherein the sizes of the pores, or the placements of the pores in different filter layers are the same or different, configured for optimizing filtration efficiency and life time between cleaning.

17. The face mask of claim 12, wherein the mask body comprises a pocket, wherein the one or more filter layers are removably inserted into the pocket.

18. The face mask of claim 17, wherein the pocket is made of a different material from the material for the one or more filter layers.

19. The face mask of claim 12, wherein the securing means comprises elastic cord, elastic band, strings, ties or straps to be placed around the ear or around the back of the wearer's head.

20. A method for fabricating a mask filter or mask body of a face mask, comprising:
providing a wafer substrate having a surface region;
depositing a first material A on the surface region of the wafer substrate;
depositing a second material B on the surface region of the first material A;
coating a resist layer on the surface region of the second material B;
patterning the resist layer to form recessed areas, using at least one of lithography and etching processes;
etching into the second material B which is selective to the first material A to form pores;
removing the resist layer, and
lifting off the left second material B via etching away the first material A to form a mask filter or mask body with well-defined pores.

21. The method of claim 20, further comprising the following steps before the last lifting step:
depositing a third material C on the surface region of the second material B and filling into the pores in the second material B;
planarization of the top surface of the third material C using etching, chemical or mechanical polishing techniques,
etching holes into the third material C, to form supporting pillars between mask layers;
depositing a fourth material D on the surface region of the third material C and filing into the holes in third material C,
coating a resist layer on the surface region of the fourth material D,
patterning the fourth material D using at least one of lithography and etching processes;
etching through the existing fourth material D which is selective to the third material C to form pores,
etching away the third material C, and
lifting off the left materials B and D via etching away the first material A to form a double-layered mask filter or mask body with well-defined pores, wherein the pores in the second material B form pores in a first layer, and the pores in the fourth material D form pores in a second layer.

22. A method for fabricating a mask filter or mask body of a face mask, comprising:
providing a wafer substrate having a surface region;
coating a resist layer on the surface region of the wafer substrate;
patterning the resist layer, using at least one of lithography and etching processes;
etching into the wafer substrate to form pores, and
removing the resist layer to form a mask filter or mask body in the substrate layer with well-defined pores.

23. The method of claim 22, wherein the wafer substrate is a silicon water substrate, the first material A comprises silicon dioxide, the second material B comprises polysilicon, the third material C comprises silicon dioxide, or the fourth material D is the same material as the second material B.

24. The method of claim 22, wherein the etching process comprises dry etching or wet etching.

25. The method of claim 22, wherein the mask filter or mask body is further cut into desired dimensions.

26. The method of claim 22, wherein the mask body is cut into desired dimensions via die cutting process; or the cutting process is performed before or after the last lifting step; or the steps of depositing, planarizing and etching the third material C, and depositing and patterning the fourth material D are repeated one or more times to form a mask comprising multiple filter layers.
